(19) United States
(12) Patent Application Publication
(10) Pub. No.: US 2015/0248285 A1
(43) Pub. Date: Sep. 3, 2015

(54) METHOD FOR ADAPTING CHANGES OF OPERATION ENVIRONMENT AND SUPPORTING UPGRADE AND EVOLUTION OF SYSTEM AND SYSTEM THEREOF

(71) Applicant: Electronics and Telecommunications Research Institute, Daejeon (KR)

(72) Inventors: Sung Joo KANG, Daejeon (KR); Jeong Min PARK, Daejeon (KR); In Geol CHUN, Daejeon (KR); Won Tae KIM, Asan (KR)

(21) Appl. No.: 14/616,446

(22) Filed: Feb. 6, 2015

(30) Foreign Application Priority Data
Feb. 28, 2014 (KR) 10-2014-0024169

(51) Int. Cl. G06F 9/445

(52) U.S. Cl. CPC G06F 8/65; G06F 8/67

(57) ABSTRACT

Provided are a method for updating a system and a system thereof that can simultaneously update a new-version application program and a device driver without interruption or restarting of the system which is developed and operating.

### CROSS-REFERENCE TO RELATED APPLICATIONS

This application claims priority to and the benefit of Korean Patent Application No. 10-2014-0024169 filed in the Korean Intellectual Property Office on Feb. 28, 2014, the entire contents of which are incorporated herein by reference.

### TECHNICAL FIELD

The present invention relates to a method and an apparatus for updating (or upgrading) a system with respect to changes of a system operation environment without interruption, and more particularly, to a method for updating a system and a system thereof that can simultaneously update a new-version application program and a device driver without interruption or restarting of the system which is developed and operating.

### BACKGROUND ART

<Requirements>

With the requirement of a mega convergence age in which various industries are converged, IT technologies including computers and software are integrated, converged, and interoperated with other engineering technologies including communication/networks, machines, control, and the like as well as traditional industries to play a key role in forming new convergent and complex industries. Good examples of the new convergent and complex industries are a monitoring-reconnoitering system (C4ISR) in which automatic navigation software controlling an airplane that is a mechanical device, power distribution software of a smart grid that controls the flow of electricity from a power plant to a home, and individual weapon systems are interoperated to one national defense system, and like. Such an IT based convergent industry system is built up through integration of individual systems that are independently developed and controlled, is dynamically evolved under the operation, and has a super large system form throughout one industry.

Efficient development and operation of an IT based convergence system are recognized as important tasks in system and software engineering fields and worldwide research institutes have established a new type of system concept and derive research issues in response thereto. The National Science Foundation (NSF) has derived cyber physical systems (CPS) as a core research field and supported research expenses to many institutes since 2006. The CPS researches embedded software controlling a physical system and inter-system complicated cooperation control. The Software Engineering Institute (SEI) of the U.S. Carnegie Mellon University has researched the System of Systems (SoS) to perform one object through interoperation among heterogeneous systems, the Ultra-Large Scale System (ULS) in which a total system can be operated while enduring a failure while respective components including a system, a person, a policy, and the like are individually developed and evolved in a complete distributed form, and the like The Fraunhofer Research Organization in Germany has presented a Smart Ecosystem in which an Internet of Service concept oriented by Information Systems and an Internet of Things concept oriented by an embedded system are converged and has researched a software engineering technique for the Smart Ecosystem.

The super large convergent and complex systems are unconditionally high in complexity, and should be continuously evolved in order to overcome exceptional situations discovered during the operation thereof even though not considered in the development stage. In particular, a system having high reliability, such as a nuclear power plant, an artificial satellite, or an airplane requires evolvability in which new requirements added during the operation of the system or enhancements for adaptation to an operating environment are reflected without influencing the operation of the total system, such as interruption or restart of the system, and this means that individual components or individual systems constituting the super large system should be individually upgraded without influencing the normal operation of the total system. An upgrade generally means a key change in software and an update means a small change before the upgrade, but herein, the upgrade is handled as a subset of the update without making a large difference.

<Dynamic Software Update Technology>

In general, in order to update software, an application process which is being executed is ended and a new version is installed and thereafter, the application process should be again executed. Dynamic software updating (DSU) is a technology that updates the executed application to a new version without ending the executed application. A method for implementing the DSU is diversified and UpStare developed by U.S. Arizona State University uses a stack reconstruction technology. This is a technology that temporarily stores a stack area of an old-version application and executes a new-version application, and thereafter, reconstructs a stack based on temporarily stored stack information upon the update. In order to drive the scheme, software converted into a ‘dynamic updatable form’ and DSU software that provides a dynamic update function are required.

<Device driver technology>

A device driver is a program that operates as a part of a kernel for controlling specific hardware or a specific device. The device driver may be made by a part of the kernel or a module which may be called. A .sys file by Microsoft Windows and a .ko module by Linux are device drivers which may be called. The module-type device driver may be loaded to a memory as necessary and restored from the memory when not being used. Further, the device driver program may be updated in such a manner that an old version of the device driver program prepared by the module may be restored from the memory and a new version is loaded.

However, since the existing dynamic software technology dynamically updates only the executed application without considering the related device drivers, the existing dynamic software technology has an inefficient problem that a system developer should separately update and maintain respective applications.

### SUMMARY OF THE INVENTION

Therefore, the present invention has been made in an effort to provide a method for updating a system that can simultaneously and integrally update an application program and a device driver by reflecting a kind and a version of the device driver when a corresponding application program is used, without interruption or restarting of the system when a dynamically updatable type application program is updated, and a system thereof.

An exemplary embodiment of the present invention provides a method for updating a system including: performing an application for system operation according to a previous-version application program generated by executing previous-version DSU software in a dynamic update manager; and integrally performing an update of the previous-version application program and the previous-version DSU driver using a device driver as an interface between the device and the application program to a new version in the dynamic update manager, according to an update request.

The update, which is integrally performed, may be performed without interruption or restarting of the system operation.

Integrally performing the update may include: (a) performing an update for the corresponding new-version DSU driver linked with the new-version DSU software received from a file system; and (b) updating the previous-version application program to a new-version application program by performing an update command for the new-version DSU software in the dynamic update manager.

The step (a) may include linking a shadow driver with the application according to the previous-version application program by executing the shadow driver, when the dynamic update manager pre-reserves the new-version DSU driver and the corresponding shadow driver.

The step (a) may include receiving the new-version DSU driver and the corresponding shadow driver according to a request of the dynamic update manager to the file system, and linking the shadow driver with the application according to the previous-version application program by executing the shadow driver.

The shadow driver may provide a latest value or a neutral value which was provided by the previous-version DSU driver, or another predefined value during a call command of the device according to the application program.

The step (a) may include removing the previous-version DSU driver from a storage means and storing and updating the new-version DSU driver in the dynamic update manager, while the device call command is converted to the shadow driver.

Step (b) may include temporarily storing data of a stack area of the application according to the previous-version application program in the dynamic update manager according to the update command; and restoring and storing the data of the stack area in a stack of the corresponding application according to the new-version application program generated by executing the new-version DSU software.

Another exemplary embodiment of the present invention provides a system operated by a dynamic software updating (DSU), including: an application program unit including a previous-version application program; a device driver used as an interface between one or more devices and the application program unit; and a dynamic update manager controlling the application program unit to perform an application for system operation according to the previous-version application program generated by executing the previous-version DSU software, in which the dynamic update manager performs an integral control of updating the previous-version application program and the previous-version DSU driver to a new version according to an update request.

The dynamic update manager may integrally perform the update to the new version without interruption or restarting of the system operation.

The dynamic update manager may perform an update for the corresponding new-version DSU driver linked with the new-version DSU software received from a file system and then update the previous-version application program to a new-version application program by performing an update command for the new-version DSU software.

The dynamic update manager may link a shadow driver with the application according to the previous-version application program by executing the shadow driver in order to update the new-version DSU driver, when the dynamic update manager pre-reserves the new-version DSU driver and the corresponding shadow driver.

The dynamic update manager may receive the new-version DSU driver and the corresponding shadow driver according to a request to the file system, and link the shadow driver with the application according to the previous-version application program by executing the shadow driver, in order to update the new-version DSU driver.

The shadow driver may provide a latest value or a neutral value which was provided by the previous-version DSU driver, or another predefined value during a call command of the device in the application program unit.

The dynamic update manager may remove the previous-version DSU driver from a storage means and loads and updates the new-version DSU driver, while the device call command is converted to the shadow driver.

The application program unit may temporarily store data of a stack area of the application according to the previous-version application program in the dynamic update manager according to the update command, and restore and store the data of the stack area in a stack of the corresponding application according to the new-version application program generated by executing the new-version DSU software, for the updating to the new-version application program.

According to the exemplary embodiment of the present invention, when a system developer performs an upgrade of the system distributed in an environment where interruption is difficult during operation, the system developer may effectively update an application program and a device driver linked with the application program through a dynamic update manager to eventually evolve the system by adapting the operation environment.

Unlike an existing technique which considers only the updating of the application program, the present invention has an advantage in that the application program and the device driver linked with the application program may be integrally updated to provide an efficient maintenance environment to the system developer.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is a block diagram of a dynamic software updatable system according to an exemplary embodiment of the present invention.

FIG. 2 is a diagram for describing an example in the case where the system of FIG. 1 is a heating system.

FIG. 3 is a flowchart for describing an operation of a dynamic software update of the system of FIG. 1.

FIG. 4 is a diagram for providing description related with describing the DSU software execution of FIG. 3.

FIG. 5 is a diagram for describing an update of a device driver of FIG. 3.

FIG. 6 is a diagram for describing an update of an application program of FIG. 3.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like reference numerals refer to like elements in the respective drawings. Further, a detailed description of an already known function and/or configuration will be skipped. In contents disclosed hereinbelow, a part required for understanding an operation according to various exemplary embodiments will be described by priority and a description of elements which may obscure the spirit of the present invention will be skipped.

Some components of the drawings may be enlarged, omitted, or schematically illustrated. An actual size is not fully reflected on the size of each component and therefore, contents disclosed herein are not limited by relative sizes or intervals of the components drawn in the respective drawings.

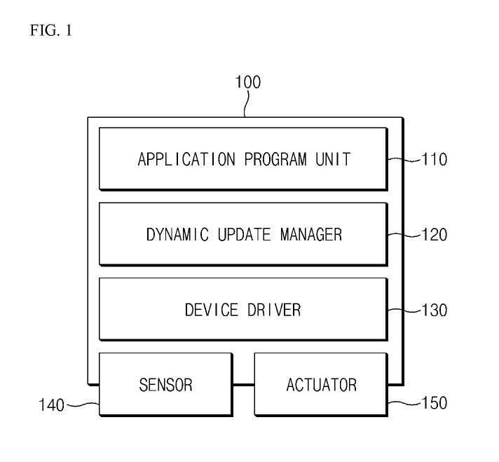

FIG. 1 is a block diagram of a dynamic software updatable (DSU) system 100 according to an exemplary embodiment of the present invention.

Referring to FIG. 1, the system 100 according to the exemplary embodiment of the present invention may include an application program unit 110, a dynamic update manager 120, a device driver 130, a sensor 140, and an actuator 150. Here, in order to maintain an operation environment of the system, as devices for performing and controlling the application by the application program unit 110, the sensor 140 and the actuator 150 are exemplified, but are not limited thereto, and one device or one or more devices may be used for the operation of the system according to the operation environment of the system.

The above constituent elements of the system 100 according to the exemplary embodiment of the present invention may be implemented in hardware, software, or a combination thereof. Furthermore, when the above constituent elements of the system 100 according to the exemplary embodiment of the present invention are executed by one or more computers or processors, the above constituent elements of the system 100 may be implemented by a processor-readable code in a processor-readable recording medium. The processor-readable recording medium includes all kinds of recording apparatuses in which processor-readable data are stored. As an example of the processor-readable recording medium, a ROM, a RAM, a CDROM, a magnetic tape, a floppy disk, an optical data storage device, and the like are included. Further, the recording medium includes media implemented in a carrier-wave form such as transmission through an Internet. Further, the processor-readable recording medium is distributed in a computer system connected to a network, and the processor-readable code may be stored and executed by a distribution method.

In FIG. 1, the device driver 130 provides an application program interface (API) among the sensor 140, the actuator 150, and the application program unit 110 (or the application program). The device driver 130 may include a program (hereinafter, referred to as a ‘DSU driver’) which is developed in a module form and can be dynamically registered and deleted.

The application program unit 110 includes a process type application program which is generated by executing software (hereinafter, referred to as ‘DSU software’) which is converted to a dynamic updatable form according to a control of the dynamic update manager 120.

The sensor 140 acquires sensing information for maintaining the operation environment of the system, and the application program unit 110 receiving the sensing information through an API controls the operation environment of the system to be maintained in a predetermined environment by executing the corresponding application for the sensing information of the sensor 140 according to the corresponding application program stored in a storing means such as a memory.

The actuator 150 receiving a control command of the application program unit 110 through the API operates according to the corresponding command to reflect the command in the operation environment of the system.

The dynamic update manager 120 performs an overall control for the dynamic software updating (DSU) for the application program unit 110 which is proposed in the present invention as described below. That is, the dynamic update manager 120 performs an integral control of a new-version update for a previous-version application program included in the application program unit 110 and a previous-version DSU driver included in the device driver 120 according to an update request and the like of a developer as described below.

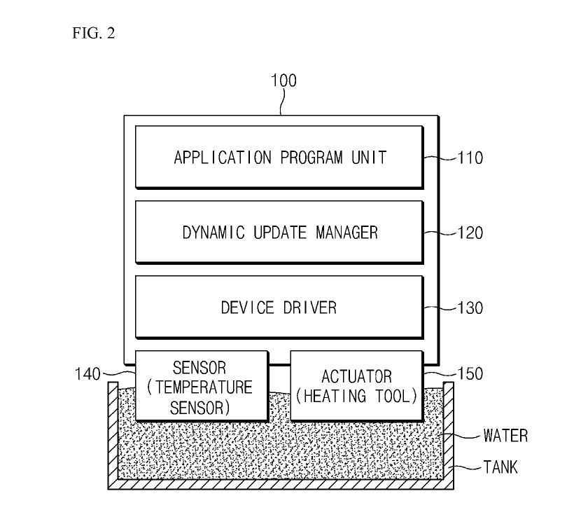

FIG. 2 is a diagram for describing an example in the case where the system 100 of FIG. 1 is a heating system.

Like FIG. 2, in the system 100, a case where the sensor 140 is a mechanical apparatus that senses a temperature of water contained in a tank by using the actuator 150 which may control a temperature sensor and a heating tool, heats the water, and maintains the temperature of the water at a predetermined temperature according to a change of the temperature of the water will be described as an example.

For example, the application program unit 110 may perform the application so that the water temperature is always maintained between 90° C. and 95° C. by operating a heating tool by controlling the actuator 150 through the API when the water temperature falls below 90° C. and stopping the heating by the heating tool by controlling the actuator 150 through the API when the water temperature exceeds 90° C.

In this case, by updating the application program of the application program unit 110, it is assumed that when salt is added into the water contained in the tank (in the case of a change of the operation environment), the water temperature needs to be maintained at 95° C. to 100° C., the output of the heating tool is increased by two times according to the control of the actuator 150 through the API when the water temperature is left below 95° C. for one minute or more, and a function that alarms the above environment and control state to the manager needs to be added.

In this case, updating (for example, adjustment of the temperature range, alarming the manager, and the like) of the application program of the application program unit 110 and updating (for example, extension of a threshold value of the output current of the heating tool and the like) of the DSU driver of the device driver 130 need to be simultaneously performed.

In the present invention, when such a system 100 is installed in a region (for example, a nuclear reactor and the like) where a user such as the manager hardly approaches or the number of like systems which need to apply the above updates is sufficiently large, according to a dynamic software update of the system 100 of the present invention as described below, the updating of the application program of the application program unit 110 and the DSU driver of the device driver 130 are integrally performed even in a remote area without the system stopping or restarting, and as a result, the updating is efficiently performed, and an environment in which the maintenance may be conveniently performed may be provided to the system developer.

To this end, as described below, in order to integrally process the updating of the application program of the application program unit 110 and the DSU driver of the device driver 130 in the system level, the dynamic update manager 120 of the present invention (1) has a function of a command of executing and updating the DSU software, (2) has a management list for a calling relationship between the DSU software and the DSU driver, (3) manages generation and extinction of a shadow driver 121, and (4) controls and manages an overall process for the updating of the application program and the DSU driver.

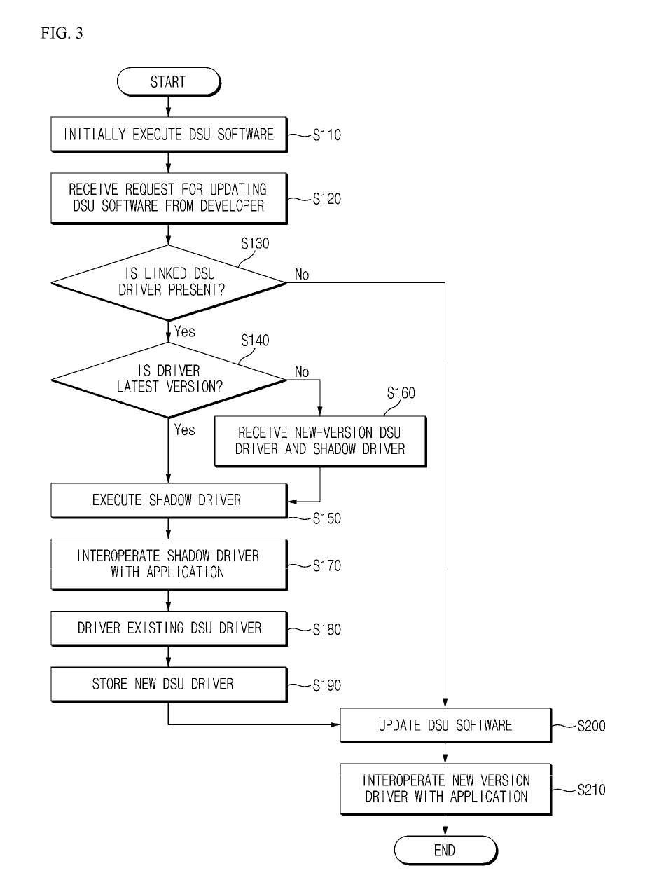

Hereinafter, an operation of the dynamic software update of the system 100 according to the exemplary embodiment of the present invention will be described in more detail with reference to a flowchart of FIG. 3.

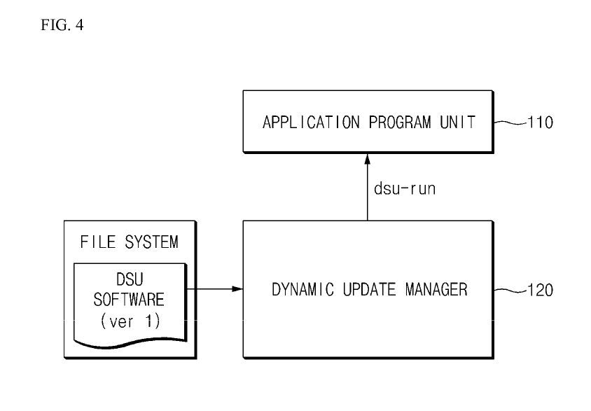

First, according to the control of the dynamic update manager 120, DSU software (for example, ver1 as an initial version (or a previous version)) distributed in an operation environment is executed through a file system (S110). The dynamic update manager 120 has a command dsu-run for executing the DSU software and a command dsu-update for updating the DSU software as new-version DSU software, and first, like FIG. 4, the dynamic update manager 120 executes the DSU software distributed by the execution command dsu-run to control the application program unit 110 to perform the application according to the application program of the corresponding process type.

Next, in the operation environment of the system 100 in which the above application is performed, when new-version ver2 DSU software is received through the file system and an update request is received through the developer or the file system (S120), the dynamic update manager 120 inquires about whether the DSU driver linked with the corresponding DSU software is present through a predetermined management list (S130). When the DSU driver linked with the new-version ver2 DSU software is present in the predetermined management list, the dynamic update manager 120 inquires about whether the corresponding DSU driver is a new version through the corresponding related information stored (S140). In the management list of the dynamic update manager 120, whether the corresponding DSU driver is present for each reserved DSU software, related information such as version information, the shadow driver, and the like may be stored and managed.

When the DSU driver linked with the new-version ver2 DSU software which is present in the management list according to such an inquiry is present in the latest version ver2, the dynamic update manager 120 executes the corresponding shadow driver for linkage with the latest-version ver2 DSU driver (S150), and links the shadow driver with the application according to the previous-version ver1 DSU software (S170).

Thereafter, the dynamic update manager 120 removes the previous-version ver1 DSU driver from a storage means such as a memory (S180), and loads and updates the corresponding latest-version ver2 DSU driver which is the new version to the storage means such as the memory (S190).

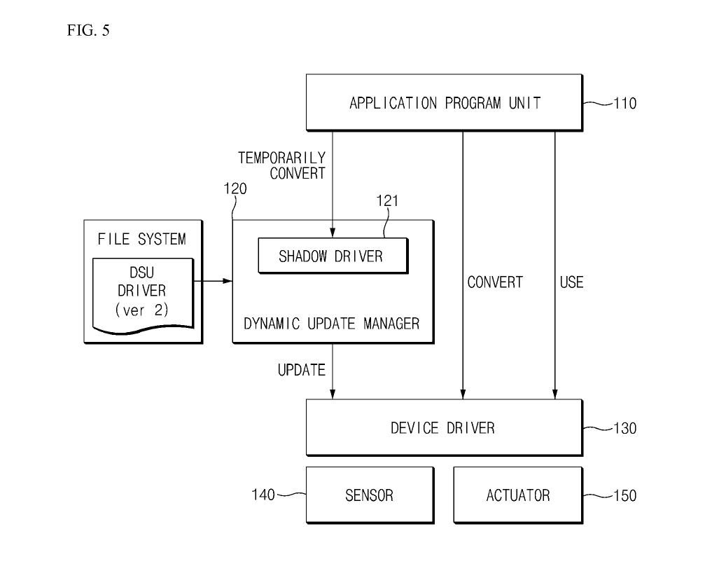

When the DSU driver to be linked with the new-version ver2 DSU software inquired in step S140 is not the latest version ver2, the dynamic update manager 120 receives the corresponding latest-version ver2 DSU driver which is the new version and the shadow driver 121 by a request to the file system like FIG. 5 to perform the above processes S150 and S170 to S190 (S160).

That is, when the application program unit 110 uses (see ‘usage’ of FIG. 5) the previous-version DSU driver which is an update target, the dynamic update manager 120 executes the corresponding shadow driver 121 for linkage with the latest-version ver2 DSU driver received from the file system (S150), and converts (see ‘temporary conversion’ of FIG. 5) a device (sensor 140, the actuator 150, and the like) call command of a temporary application program unit 110 to the shadow driver 121 instead of the corresponding device by linking the shadow driver with the application according to the previous-version ver1 DSU software (S170).

The shadow driver 121 serves to provide a predetermined value so that the software is not blocked during the device call command of the application program unit 110. For example, in the case where the update target is setting for the sensor 140 of the DSU driver, the shadow driver 121 may provide a latest value or a neutral value which was provided by an original driver which is the previous version ver1 or another predefined value. Similarly, in the case where the update target is setting for the actuator 150 of the DSU driver, the shadow driver 121 may provide a latest value or a neutral value (for example, a medium value of the upper limit and the lower limit) which was provided by the original driver which is the previous version ver1 or another predefined value.

As such, while the device call command of the application program unit 110 is converted to the shadow driver 121, the dynamic update manager 120 removes the previous-version DSU driver from the storage means such as the memory (S180), and loads and updates (see ‘update’ of FIG. 5) the new-version ver2 DSU driver in the storage means such as the memory (S190). When the new-version ver2 DSU driver is updated, the device call such as the sensor 140 and the actuator 150 is performed through the new-version ver2 DSU driver according to the device call command of the application program unit 110 and converted (see ‘conversion’ of FIG. 5) to be controlled.

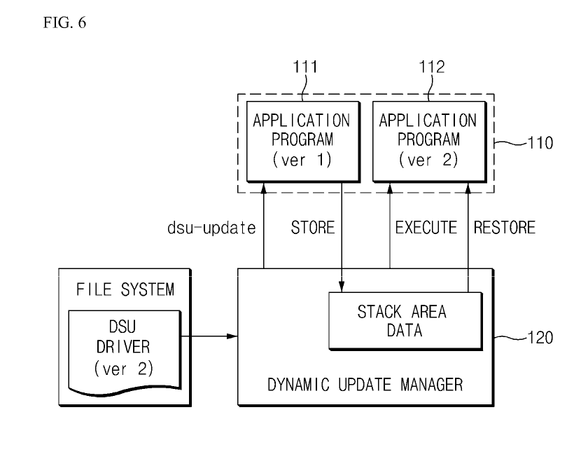

As such, when the new-version ver2 DSU driver linked with the new-version ver2 DSU software is prepared before the update of the DSU software (S130 to S190), the dynamic update manager 120 performs a DSU software update command dsu-update like FIG. 6 to control the application program unit 110 to be updated to the application program for the new-version ver2 DSU software. When the new-version ver2 DSU software is executed according to the control of the dynamic update manager 120, the application program unit 110 may maintain the environment of the system 100 according to the new application according to the corresponding application program and the new-version ver2 DSU driver (S210).

The DSU software update in step S200 will be described in more detail with reference to FIG. 6.

When the requirement occurs during the operation of the system 100, the new-version ver2 DSU software which is newly prepared by the developer is stored in the file system of the system to be transmitted to the dynamic update manager 120, and when the new-version ver2 DSU driver linked with the new-version ver2 DSU software is prepared before the update of the DSU software (S130 to S190), the dynamic update manager 120 issues the DSU software update command dsu-update. Accordingly, the application program unit 110 temporarily stores (see ‘store’ of FIG. 6) data of a stack area in which various call-related parameters of the application according to a previous-version ver1 update target application program 111 in the dynamic update manager 120 and extinguishes (removes) the previous-version ver1 update target application program 111.

As such, when the previous-version ver1 update target application program 111 is extinguished, the dynamic update manager 120 generates a new-version ver2 application program having a process type by executing (see ‘execution’ of FIG. 6) the new-version ver2 DSU software 112 and stores the generated new-version ver2 application program in the application program unit 110 and controls the application program unit 110 to perform the corresponding application according thereto. Thereafter, the dynamic update manager 120 restores (see ‘restore’ of FIG. 6) and stores the data in the temporarily stored stack area in the stack of the application according to the new-version ver2 DSU software.

As described above, there is a large effect in the case where the system 100 according to the exemplary embodiment of the present invention is installed in a region (for example, a nuclear reactor and the like) where a user such as the manager hardly approaches or the number of like systems which need to apply the above updates is sufficiently large. That is, according to the dynamic software update method of the system 100 of the present invention, the updating of the application program of the application program unit 110 and the DSU driver of the device driver 130 may be integrally performed even in a remote area without interruption or restarting of the system operation, and as a result, the updating may be efficiently performed, and an environment in which the maintenance may be conveniently performed may be provided to the system developer.

The specified matters and limited embodiments and drawings such as specific components in the present invention have been disclosed for illustrative purposes, but are not limited thereto, and those skilled in the art will appreciate that various modifications and changes can be made in the art to which the present invention belongs, within the scope without departing from an essential characteristic of the present invention. The spirit of the present invention is defined by the appended claims rather than by the description preceding them, and the claims to be described below and it should be appreciated that all technical spirit which are evenly or equivalently modified are included in the claims of the present invention.

What is claimed is:

1. A method for updating a system, comprising:
performing an application for system operation according to a previous-version application program generated by executing previous-version DSU software in a dynamic update manager; and
integrally performing updating the previous-version application program and the previous-version DSU driver of a device driver for an interface between the device and the application program to a new version in the dynamic update manager, according to an update request.

2. The method of claim 1, wherein the updating which is integrally performed is performed without interruption or restarting of the system operation.

3. The method of claim 1, wherein the integrally performing of the update includes:
(a) performing an update for the corresponding new-version DSU driver linked with the new-version DSU software received from a file system; and
(b) updating the previous-version application program to a new-version application program by performing an update command for the new-version DSU software in the dynamic update manager.

4. The method of claim 3, wherein the step (a) includes linking a shadow driver with the application according to the previous-version application program by executing the shadow driver, when the dynamic update manager pre-reserves the new-version DSU driver and the corresponding shadow driver.

5. The method of claim 3, wherein the step (a) includes receiving the new-version DSU driver and the corresponding shadow driver according to a request of the dynamic update manager to the file system, and linking the shadow driver with the application according to the previous-version application program by executing the shadow driver.

6. The method of claim 4, wherein the shadow driver provides a latest value or a neutral value which was provided by the previous-version DSU driver, or another predefined value during a call command of the device according to the application program.

7. The method of claim 4, wherein step (a) includes removing the previous-version DSU driver from a storage means and loading and updating the new-version DSU driver in the dynamic update manager, while the device call command is converted to the shadow driver.

8. The method of claim 3, wherein step (b) includes temporarily storing data of a stack area of the application according to the previous-version application program in the dynamic update manager according to the update command; and
restoring and storing the data of the stack area in a stack of the corresponding application according to the new-version application program generated by executing the new-version DSU software.

9. A system operated by a dynamic software updating (DSU), comprising:
an application program unit including a previous-version application program;
a device driver for an interface between one or more devices and the application program unit; and
a dynamic update manager controlling the application program unit to perform an application for system operation according to the previous-version application program generated by executing the previous-version DSU software,
wherein the dynamic update manager performs an integral control of updating the previous-version application program and the previous-version DSU driver to a new version according to an update request.

10. The system of claim 9, wherein the dynamic update manager integrally performs the updating to the new version without interruption or restarting of the system operation.

11. The system of claim 9, wherein the dynamic update manager performs updating for the corresponding new-version DSU driver linked with the new-version DSU software received from a file system and then updates the previous-version application program to a new-version application program by performing an update command for the new-version DSU software.

12. The system of claim 11, wherein the dynamic update manager links a shadow driver with the application according to the previous-version application program by executing the shadow driver in order to update the new-version DSU driver, when the dynamic update manager pre-reserves the new-version DSU driver and the corresponding shadow driver.

13. The system of claim 11, wherein the dynamic update manager receives the new-version DSU driver and the corresponding shadow driver according to a request to the file system, and links the shadow driver with the application according to the previous-version application program by executing the shadow driver, in order to update the new-version DSU driver.

14. The method of claim 12, wherein the shadow driver provides a latest value or a neutral value which was provided by the previous-version DSU driver, or another predefined value during a call command of the device in the application program unit.

15. The method of claim 12, wherein the dynamic update manager removes the previous-version DSU driver from a storage means and loads and updates the new-version DSU driver, while the device call command is converted to the shadow driver.

16. The system of claim 11, wherein the application program unit temporarily stores data of a stack area of the application according to the previous-version application program in the dynamic update manager according to the update command, and restores and stores the data of the stack area in a stack of the corresponding application according to the new-version application program generated by executing the new-version DSU software, for the updating to the new-version application program.
